(19) United States
(12) Patent Application Publication
(10) Pub. No.: US 2014/0194178 A1
(43) Pub. Date: Jul. 10, 2014

(54) SERVER DEVICE FOR RECOMMENDING GAME CONTENT

(71) Applicant: DeNA Co., Ltd., Tokyo (JP)

(72) Inventors: Hotaka KAWADA, Tokyo (JP); Naoto YOSHIE, Tokyo (JP)

(73) Assignee: DeNA Co., Ltd., Tokyo (JP)

(21) Appl. No.: 14/109,472

(22) Filed: Dec. 17, 2013

(30) Foreign Application Priority Data
Jan. 7, 2013 (JP) 2013-000711

(51) Int. Cl. G07F 17/32

(52) U.S. Cl. CPC G07F 17/3225; G07F 17/329
USPC 463/17; 463/31

(57) ABSTRACT

One object is to provide a setup for recommending a game content more effectively. In accordance with one aspect, a server device according to an embodiment includes: a game progress control unit for controlling the game progress; an information storage unit for storing information; a determination unit for determining whether a player owns a game content that requires a change in display mode of a screen containing a guidance display area for guiding the player to a gasha screen for obtaining a card as a game content; and a display control unit for displaying the screen containing the guidance display area on the terminal device.

### CROSS-REFERENCE TO RELATED APPLICATIONS

This application is based on and claims the benefit of priority from Japanese Patent Application Serial No. 2013-000711 (filed on Jan. 7, 2013), the contents of which are hereby incorporated by reference in their entirety.

### TECHNICAL FIELD

The present invention relates to a server device and a program used on the server device, and in particular, to a server device communicatively connected to a terminal device and capable of providing a game to a player operating the terminal device, and a program used on the server device.

### BACKGROUND

Conventionally known such server devices include a server device for providing games via a network such as the Internet to terminal devices such as smartphones, tablet terminals, personal computers, or game-dedicated terminals. Games provided by such server devices use virtual game contents such as cards and items; and players obtain such game contents and progress the game with the obtained game contents (see, e.g., Japanese Patent Application Publication No. 2002-282534). These games provide various cards having different parameters and attributes such as rarity so as to enhance the playability; and players combine cards with each other, fuse cards with each other, and apply items to cards, thereby to progress the games advantageously.

However, it is not easy for novice game players to use these various game contents effectively. There is a need for a setup in which novice game players can use owned game contents effectively.

### SUMMARY

One object of the present invention is to provide a setup for recommending game contents more effectively. Other objects of the present invention will be apparent with reference to the entire description in this specification.

A server device according to an embodiment of the present invention is a server device communicatively connected to a terminal device and capable of providing a game to a player operating the terminal device, the server device comprising: a storage unit configured to store owned game content information on game contents owned by the player and used in the game; a determination unit configured to determine whether the player owns a particular game content based on the owned game content information; and a display control unit configured to cause the terminal device operated by the player to display, in a particular display mode, a screen containing a guidance display area for guiding the player to a particular screen used in the game if the determination unit determines that the player does not own the particular game content, and cause the terminal device operated by the player to display the screen containing the guidance display area in a display mode for notifying a game content recommended based on the particular game content if the determination unit determines that the player owns the particular game content.

A program according to an embodiment of the present invention causes a computer to operate as the server device according to the above embodiment of the present invention.

Various embodiments of the present invention provide a setup for recommending game contents more effectively.

### BRIEF DESCRIPTION OF THE DRAWINGS

FIG. 1 is a block diagram schematically illustrating a network configuration of a system including a server device according to an embodiment of the present invention.

FIG. 2 is a block diagram schematically illustrating the architecture of a terminal device according to an embodiment.

FIG. 3 is a block diagram illustrating the functionality of the server device according to an embodiment.

FIG. 4 is a diagram showing a specific example of a game content management table according to an embodiment.

FIG. 5 is a diagram showing a specific example of an owned game content management table according to an embodiment.

FIG. 6 is a flow diagram showing an example of a display control process according to an embodiment.

FIG. 7 is a diagram showing an example of My Menu screen according to an embodiment.

FIG. 8 is a diagram showing an example of My Menu screen according to an embodiment.

### DESCRIPTION OF EXAMPLE EMBODIMENTS

Various embodiments of the present invention will be described hereinafter with reference to the drawings. In the drawings, the same components are denoted by the same reference numerals.

FIG. 1 is a block diagram schematically illustrating a system including a server device 10 according to an embodiment of the present invention. As illustrated in FIG. 1, the server device 10 according to an embodiment may be communicatively connected to a plurality of terminal devices 30-1, 30-2, . . . , and 30-N (hereinafter also collectively referred to as the “terminal devices 30”), each having a communication function, via a communication network 20 such as the Internet. The server device 10 may provide players operating the terminal devices 30 with various services such as games.

As illustrated in FIG. 1, a server device 10 according to an embodiment may include a central processing unit (CPU) 11, a main memory 12, a user interface (I/F) 13, a communication I/F 14, an external memory 15, and a disk drive 16, and these components may be electrically connected to one another via a bus 17. The CPU 11 may load an operating system and various programs into the main memory 12 from the external memory 15, and may execute commands included in the loaded programs. The main memory 12 may be used to store a program to be executed by the CPU 11, and may be formed of, for example, a dynamic random access memory (DRAM).

As illustrated in FIG. 1, the server device 10 may include a central processing unit (CPU) 11, a main memory 12, a user interface (I/F) 13, a communication I/F 14, an external memory 15, and a disk drive 16, and these components may be electrically connected to one another via a bus 17. The CPU 11 may load an operating system and various programs for controlling the progress of an online game into the main memory 12 from the external memory 15, and may execute commands included in the loaded programs. The main memory 12 may be used to store a program to be executed by the CPU 11, and may be formed of, for example, a dynamic random access memory (DRAM).

The user I/F 13 may include, for example, an information input device such as a keyboard or a mouse for accepting an input from an operator, and an information output device such as a liquid crystal display for outputting calculation results of the CPU 11. The communication I/F 14 may be implemented as hardware, firmware, or communication software such as a transmission control protocol/Internet protocol (TCP/IP) driver or a point-to-point protocol (PPP) driver, or a combination thereof, and may be configured to be able to communicate with the terminal devices 30 via the communication network 20.

The external memory 15 may be formed of, for example, a magnetic disk drive and store various programs such as a control program for controlling the progress of an online game. The external memory 15 may also store various data used in the game. The various data that may be stored in the external memory 15 may also be stored on a database server communicatively connected to the server device 10 and physically separate from the server device 10. The disk drive 16 may read data stored in a storage medium such as a compact disc read only memory (CD-ROM), digital versatile disc read only memory (DVD-ROM), or DVD Recordable (DVD-R) disc, or write data to such a storage medium. For example, a game application and data such as game data stored in a storage medium may be read by the disk drive 16, and may be installed into the external memory 15.

In an embodiment, the server device 10 may be a web server for managing a web site including a plurality of hierarchical web pages and may be capable of providing the terminal devices 30 with game services. The terminal devices 30 may fetch HTML data for rendering a web page from the server device 10 and analyze the HTML data to present the web page to a user (a player of the game) of the terminal devices 30. A game provided through such a web page is sometimes called a browser game. The HTML data for rendering the web page may also be stored on the external memory 15. The HTML data may comprise HTML documents written in markup languages such as HTML; the HTML documents may be associated with various images. Additionally, the HTML documents may include programs written in script languages such as ActionScript™ and JavaScript™.

The external memory 15 may store game applications to be executed on execution environments of the terminal device 30 other than browser software. This game application may include game programs for performing a game and various data such as image data to be referred to for executing the game programs. The game programs may be created in, for example, object oriented languages such as Objective-C™ and Java™. The created game programs may be stored on the external memory 15 in the form of application software along with various data. The application software stored on the external memory 15 may be delivered to a terminal device 30 in response to a delivery request. The application software delivered from the server device 10 may be received by the terminal device 30 through a communication I/F 34 in accordance with the control of CPU 31; the received game programs may be sent to an external memory 35 and stored thereon. The application software may be launched in accordance with the player's operation on the terminal device 30 and may be executed on a platform implemented on the terminal device 30 such as NgCore™ or Android™. The server device 10 may provide the game applications executed on the terminal devices 30 with various data required for progression of the games. Additionally, the server device 10 can store various data sent from the terminal device 30 for each player, thereby managing the progression of the game for each player.

Thus, the server device 10 may manage the web site for providing game services and deliver web pages constituting the web site in response to a request from the terminal device 30, thereby progressing the game. Also, the server device 10 can progress a game by communicating with a game application performed on the terminal device 30 in place of, or in addition to, such a browser game. Whichever mode may be taken to provide the game, the server device 10 can store data required to progress the game for each identification identifying a player. Briefly, the server device 10 may also include a function to authenticate a player at start of the game and perform charging process in accordance with progression of the game. The games provided by the server device 10 may include desired games such as action games, role playing games, interactive baseball games, and card games. The types of the games implemented by the web site or game applications of the server device 10 are not limited to those explicitly described herein.

In an embodiment, the terminal device 30 may be any information processing device that may display on a web browser a web page of a game web site obtained from the server device 10 and include an application executing environment for executing game applications.

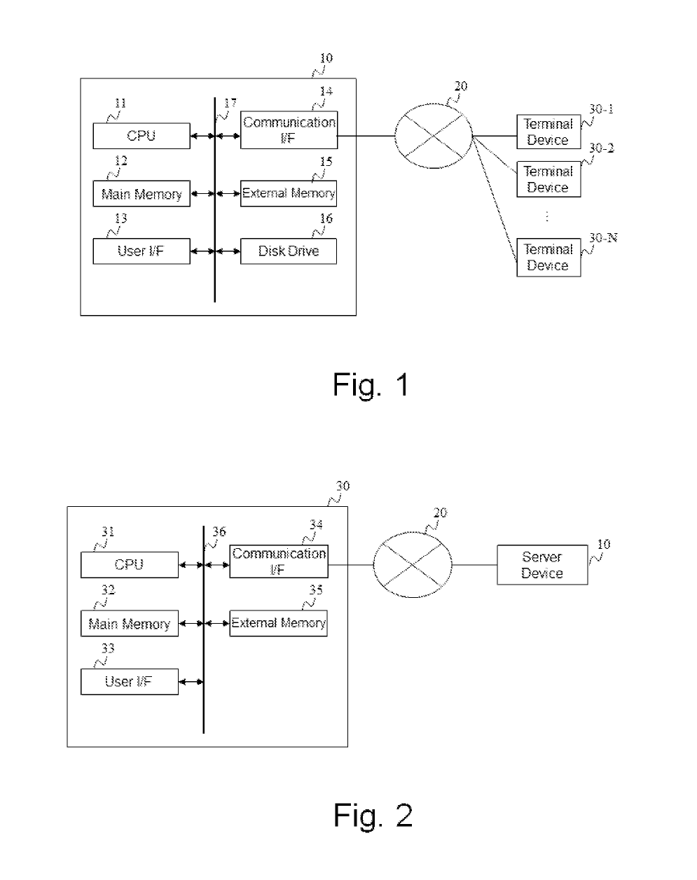

The architecture of the terminal device 30 will now be described with reference to FIG. 2. FIG. 2 is a block diagram schematically illustrating the architecture of a terminal device 30. As illustrated in FIG. 2, the terminal device 30 may include a central processing unit (CPU) 31, a main memory 32, a user interface (I/F) 33, a communication I/F 34, and an external memory 35, and these components may be electrically connected to one another via a bus 36.

The CPU 31 may load various programs such as an operating system into the main memory 32 from the external memory 35, and may execute commands included in the loaded programs. The main memory 32 may be used to store a program to be executed by the CPU 31, and may be formed of, for example, a dynamic random access memory (DRAM).

The user I/F 33 may include, for example, an information input device such as a touch panel, a keyboard, a button, and a mouse for accepting an input from a player (user), and an information output device such as a liquid crystal display for outputting calculation results of the CPU 31. The communication I/F 34 may be implemented as hardware, firmware, or communication software such as a transmission control protocol/Internet protocol (TCP/IP) driver or a point-to-point protocol (PPP) driver, or a combination thereof, and may be configured to be able to communicate with the server device 10 via the communication network 20.

The external memory 35 may comprise, for example, a magnetic disk drive or a flash memory and store various programs such as an operating system. When receiving a game application from the server device 10 via the communication I/F 34, the external memory 35 may store the received game application.

A terminal device 30 having such an architecture may include, for example, browser software for interpreting an HTML file (HTML data) and rendering a screen; this browser software may enable the terminal device 30 to interpret the HTML data fetched from the server device 10 and render web pages corresponding to the received HTML data. Further, the terminal device 30 may include plug-in software (e.g., Flash Player distributed by Adobe Systems Incorporated) embedded into browser software; therefore, the terminal device 30 can fetch from the server device 10 a SWF file embedded in HTML data and execute the SWF file by using the browser software and the plug-in software.

When a game is executed on the terminal device 30, for example, animation or an operation icon designated by the program may be displayed on a screen of the terminal device 30. The player may enter an instruction for causing the game to progress using an input interface of the terminal device 30. The instruction entered by the player may be transmitted to the server device 10 through the browser of the terminal device 30 or a platform function such as NgCore™.

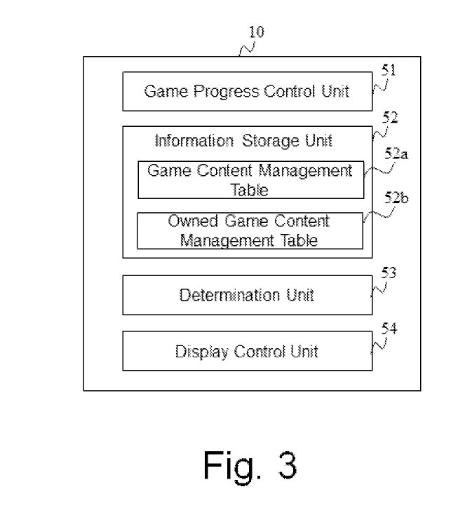

Next, the functionality of the server device 10 implemented by the components shown in FIG. 1 will now be described As described above, the server device 10, which can provide various games, will now be described with a focus on functions related to card games. Card games are examples suitable for description of an embodiment of the present invention. FIG. 3 is a block diagram illustrating the functionality of a server device 10 according to an embodiment of the present invention. As shown, the server device 10 may comprise: a game progress control unit 51 for controlling the game progress; an information storage unit 52 for storing information; a determination unit 53 for determining whether a player owns a game content that requires a change in display mode of a screen containing a guidance display area for guiding a player to a gasha screen for obtaining a card as a game content; and a display control unit 54 for displaying the screen containing the guidance display area on the terminal device 30. These functions may be implemented through cooperation between the CPU 11 of the server device 10 and various programs, tables, and the like stored in the main memory 12 and the external memory 15.

The game progress control unit 51 may send and receive various data required for the progression of the game to and from the terminal device 30 and manage such data for each player, thereby controlling the progression of the game for each player. For example, the game progress control unit 51 can sequentially display, on the terminal device 30, web pages constituting a web site for providing game services in response to a request from the terminal device 30. When a hyperlink on the displayed web page is selected by the player, the game progress control unit 51 may send new HTML data corresponding to the hyperlink to the terminal device 30. The terminal device 30 may display a web page based on the new HTML data. Thus, the game progress control unit 51 may control the game such that web pages stored on the server device 10 are sequentially provided to the terminal device 30 in accordance with the operation by the player; and the player can progress the game by his own operation through the function of the game progress control unit 51. Additionally, the game progress control unit 51 and the display control unit 54 may cooperate with each other to control the display of the above-mentioned screen containing the guidance display area on the terminal device 30.

When the terminal device 30 executes the game application, the game progress control unit 51 can send various data used in the game to the game application. For example, when receiving from a game application on the terminal device 30 a control signal indicating that a certain mission has been cleared, the game progress control unit 51 may provide the game application with various parameters related to a mission subsequent to the cleared mission. The game application may load the data provided by the server device 10 and progress the game.

The terminal device 30 can appropriately send to the server device 10 various information on progression of the game such as information indicating various parameter values used in the game (information on earned game points and earned items) and information indicating a status (information specifying a fulfilled mission), through the function of browser software or the game application. The game progress control unit 51 may store, for each player, information on the progression of the game received from a plurality of terminal devices 30, thereby controlling the progression of the game for each player. Thus, when the player logs in the server device 10 using his own ID, the game may be resumed from the stage corresponding to the progression of the player (e.g., the stage where the game was interrupted) based on the information on the progression of the game associated with the player stored in the server device 10. The information required for the progression of the game may also be managed by various functions of the server device 10 other than the game progress control unit 51.

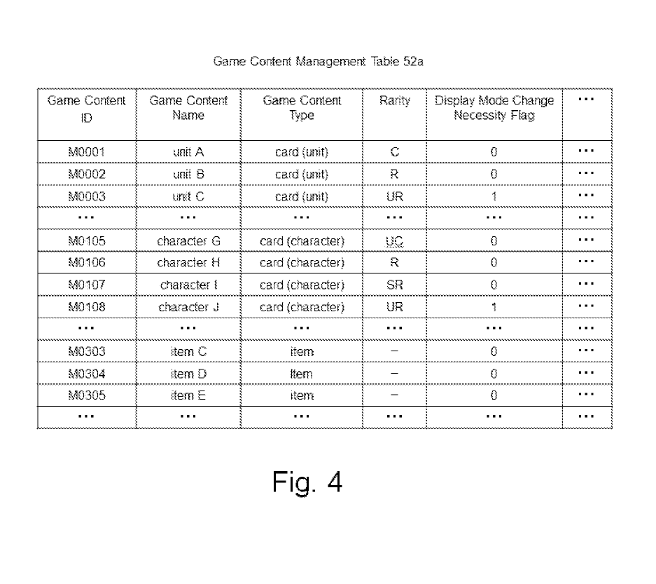

The information storage unit 52 may include: a game content management table 52a for managing information on game contents used in a card game; and an owned game content management table 52b for managing information on game contents owned by players. FIG. 4 illustrates a specific example of the game content management table 52a. As shown, the game content management table 52a may manage, in association with “game content ID” identifying a game content, information such as “game content name” of the game content, “game content type” of the game content, “rarity” indicating the rarity value of the game content, and “display mode change necessity flag” indicating whether it is necessary to change the display mode of the guidance display area when the player owns the game content. In an embodiment, values of “game content type” may include “unit card” (card (unit)), “character card” (card (character)), and “item.” “Rarity” may be assigned to game contents having a game content type of “unit card” or “character card,” not to game contents having a game content type of “item.” Values of “rarity” may include “common” (C), “uncommon” (UC), “rare” (R), “super rare” (SR), and “ultra rare” (UR). Additionally, the necessity of change in display mode of the guidance display area may also be determined based on information other than “display mode change necessity flag.” For example, it may be possible to determine that a change in display mode of the guidance display area is necessary when the “rarity” value is “ultra rare” (UR) and otherwise determine that a change in display mode of the guidance display area is unnecessary. The game content management table 52a may manage information on game contents including various parameters and attributes such as ability values, in addition to the above examples of information. In an embodiment, the game content management table 51a may manage information on unit cards, character cards, and items; but this is not the only table that can manage such information. For example, it may also be possible that a plurality of tables manage such information. For more specific example, the game content management table 52a may manage only information on cards (unit cards and character cards), and another table may manage information on items.

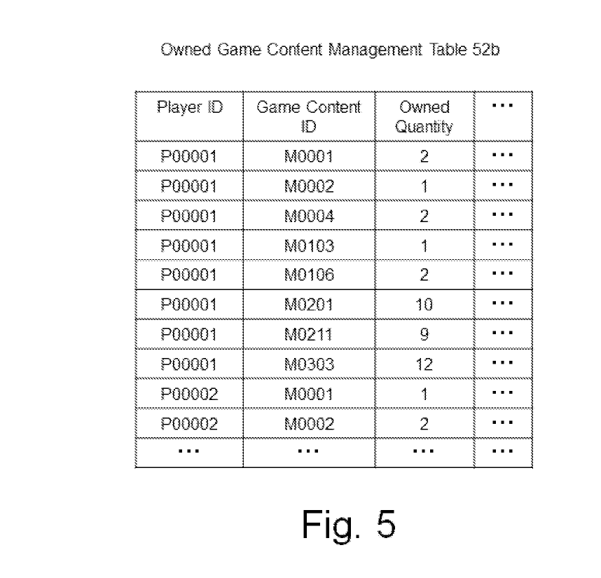

FIG. 5 illustrates a specific example of the owned game content management table 52b. As shown, the owned game content management table 52b may manage, in association with “player ID” identifying a player, information such as “game content ID” of game contents owned by the player and “owned quantity” indicating the number of the owned game contents.

The basic flow of a card game will now be described as an embodiment of the present invention. This card game may use the above-mentioned various game contents. A player may progress a plurality of prepared missions, wherein the player may obtain unit cards, character cards, and items, while acquiring experience points and raising the player's own level. Further, the player can combine the obtained unit cards and character cards to organize a unitary pair, and enjoy a battle with a boss or other characters by using one or more organized unitary pairs. In organizing a unitary pair, any desired combination of unit cards and character cards is possible; but special combinations that can progress the game advantageously (e.g., raise an ability value impacting an outcome of a battle) may be preset. Also, parameters of a unit card such as ability values may be raised by applying (fusing) a unit card or an item to (with) the unit card. Likewise, parameters of a character card such as ability values may be raised by applying a character card or an item to the character card. When a unit card is fused with another unit card, a special effect (e.g., rise in the upper limit of the level) may be produced if the types of the unit cards are the same. Game contents such as cards and items can be obtained by performing a lottery (gasha), winning a battle with another player, exchanging (trading) game contents with another player, receiving a game content as a present, as well as progressing the missions. When a game content is obtained in these various cases, the game progress control unit 51 may update the information in the owned game content management table 52b.

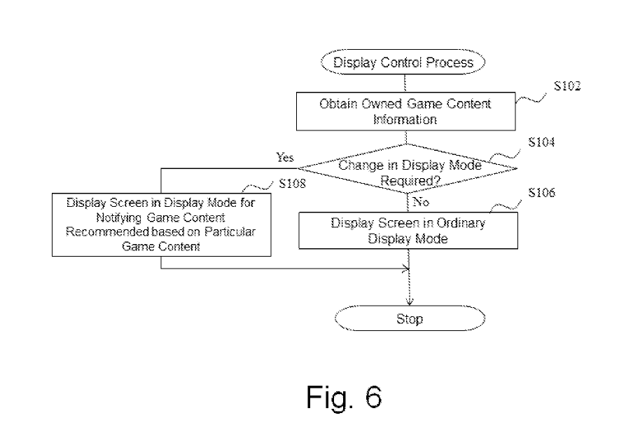

Next, operations of such a server device 10 as an embodiment of the present invention will now be described. FIG. 6 is a flow diagram showing an example of a display control process performed by the server device 10. The display control process may be performed when the server device 10 receives from a terminal device 30 a display request for the screen containing a guidance display area for guiding a player to a gasha screen for obtaining a card through a lottery among screens used in the card game. Various examples of the screens containing the guidance display area for the gasha screen may include a top screen displayed after log-in to the card game, My Menu screen from which the player may progress the card game, and a fusion screen for applying (fusing) a card or an item to (with) another card.

The first step of the display control process may be to obtain information on the game contents owned by the player operating the terminal device 30 which sent a display request for the screen containing the guide display area (step S102). More specifically, the determination unit 53 may access the game content management table 52a and the owned game content management table 52b of the information storage unit 52 to obtain information on game contents owned by the player operating the terminal device 30.

Next step may be to determine whether the player owns a game content that requires a change in display mode of the guidance display area (hereinafter also referred to as “a particular game content”) based on the obtained information on game contents owned by the player (step S104). As described above, the necessity of a change in display mode of the guidance display area may be preset for each game content, and can be determined by referring to the “display mode change necessity flag” in the game content management table 52a. In an embodiment, it can be determined that, when the value of the “display mode change necessity flag” is “1,” a change in display mode of the guidance display area may be necessary, and when the value is “0,” the change may be unnecessary

If, as a result of such a determination, it is determined that the player does not own a particular game content, the screen containing the guidance display area may be displayed on the terminal device 30 in an ordinary display mode (step S106); and if it is determined that the player owns a particular game content, the screen containing the guidance display area may be displayed on the terminal device 30 in a display mode for notifying a game content recommended based on the particular game content (step S108). Then, the display control process may be ended. Now description will be made on My Menu screen 70 from which the player progresses the card game, as an example of the screen containing a guidance display area displayed in an ordinary display mode and the screen containing a guidance display area displayed in a display mode for notifying a game content recommended based on the particular game content.

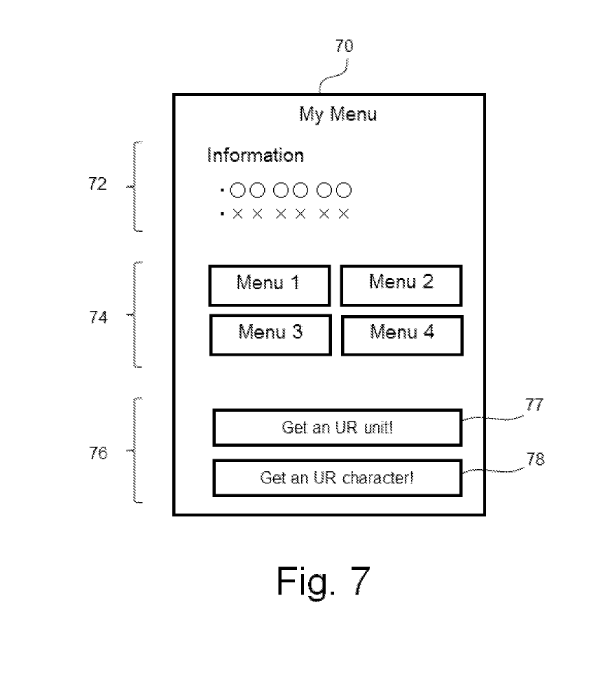

FIG. 7 is a diagram showing an example of My Menu screen 70 displayed in an ordinary display mode. As shown, My Menu screen 70 may contain a notification section 72 for displaying information on the card game to be notified to the player, a menu section 74 for the player to select an action menu for progressing the card game, and a guidance display section 76 for guiding the player to a gasha screen; and these areas are arranged in the order from the upper portion to the lower portion of the screen. The notification section 72 may display information to be notified to the player, for example, information notifying a special game event or information notifying that a game content has been provided from another player as a present. The notification section 72 may include a hyperlink to another screen that shows details of the information to be notified to the player. The menu section 74 may display menus corresponding to various actions selectable to the player, such as start of a mission, fusion of cards, sales of cards, exchange (trade) of cards with other players, setting of combination (a unitary pair) of a unit card and a character card, a battle with other players, and purchase of an item. When the player selects a menu, the screen may transition to a screen for the action corresponding to the selected menu.

As shown, the guidance display section 76 of My Menu screen 70 may include a unit card lottery screen guidance display area 77 for guiding the player to a unit card gasha screen for obtaining a unit card through a lottery (screen transition), and a character card lottery screen guidance display area 78 for guiding the player to a character card gasha screen for obtaining a character card through a lottery (screen transition). In the ordinary display mode as shown, the unit card lottery screen guidance display area 77 may contain an image including the text “Get an UR unit!” for example; and the character card lottery screen guidance display area 78 may contain an image including the text “Get an UR character!” for example. The ordinary display mode of the unit card lottery screen guidance display area 77 and the character card lottery screen guidance display area 78 is not limited to the display mode shown in FIG. 7. For example, an ordinary display mode may be to notify and recommend, to the player, a unit card or a character card recommended by a card game provider irrespective of what cards are owned by the player.

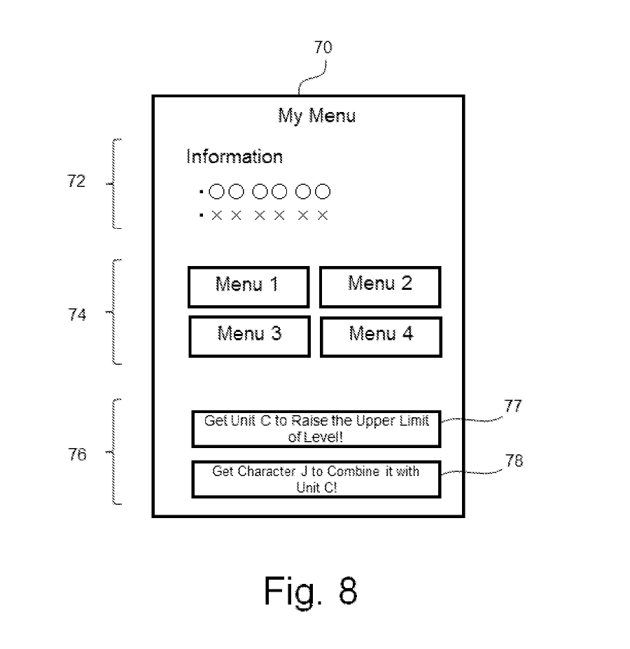

FIG. 8 is a diagram showing an example of My Menu screen 70 in a display mode for notifying a game content recommended based on a particular game content owned by the player. As in the embodiment shown, when the player owns the particular game content, the images contained in the unit card lottery screen guidance display area 77 and the character card lottery screen guidance display area 78 are different from those in My Menu screen 70 displayed in the ordinary display mode shown in FIG. 7. FIG. 8 shows an example wherein the player owns “unit C” that requires a change in display mode of the guidance display areas; in this case, the unit card lottery screen guidance display area 77 may contain an image including the text “Get unit C to raise the upper limit of level!”; and the character card lottery screen guidance display area 78 may contain an image including the text “Get character J to combine it with unit C!” As described above, this card game is configured such that a special effect is produced when a unit card is fused with a same unit card; and the unit card lottery screen guidance display area 77, containing an image including the text “Get unit C to raise the upper limit of level!,” may recommend fusion of one unit C with another and guide the player to the unit card gasha screen. Likewise, as described above, this card game has a preset special combination of a unit card and a character card in unitary pair organization such that the game can be progressed advantageously; and the character card lottery screen guidance display area 78, containing an image including the text “Get character J to combine it with unit C!,” may recommend combination of unit C with character J and guide the player to the character card gasha screen (in this example, unit C and character J form a special combination). The text included in the unit card lottery screen guidance display area 77 and the character card lottery screen guidance display area 78 may be previously stored on the information storage unit 52 (e.g., the game content management table 52a) for each particular game content. The above setting wherein a special effect is produced when a unit card is fused with a same unit card is a mere example and may naturally be replaced with another setting in accordance with game designs. For example, when the game is configured such that fusion of unit C with unit E produces a special effect, the unit card lottery screen guidance display area 77 may contain an image including the text “Get unit E and fuse it with unit C!”

The above example shown in FIG. 8 is based on the case where the player owns a unit card (unit C) as a game content requiring a change in display mode of the guidance display areas; and the same also applies to the case where the player owns a character card as a game content that requires a change in display mode of the guidance display areas. For example, when the player owns a character card “character J” that requires a change in display mode of the guidance display areas, the unit card lottery screen guidance display area 77 may contain an image including the text “Get unit C to combine it with character J!”; and the character card lottery screen guidance display area 78 may contain an image including the text “Get character J to raise the upper limit of level!” Additionally, it may also be possible to set only one of a unit card and a character card as a card that requires a change in display mode of the guidance display areas.

In an embodiment, when the player owns a plurality of particular game contents, screens containing a guidance display area such as My Menu screen 70 may be displayed in a display mode corresponding to the last obtained particular game content among the plurality of particular game contents. The last obtained particular game content may be determined by managing the latest obtaining date for each game content in the owned game content management table 52b for managing information on game contents owned by players. The process performed when the player owns a plurality of particular game contents may be other than the above process. For example, it may also be possible to previously prioritize the particular game contents so as to display a screen containing a guidance display area in a display mode corresponding to the particular game content having the highest priority among the plurality of particular game contents owned by the player. In this case, the game content management table 52a may manage the priorities of the particular game contents.

When the player selects the unit card lottery screen guidance display area 77 or the character card lottery screen guidance display area 78 of the My Menu screen 70, the screen may transition to a unit card gasha screen or a character card gasha screen (both not shown), and the player may obtain a unit card or a character card through a lottery. Since such a process for obtaining a card through a lottery is conventional to those skilled in the art, further detailed description is omitted.

In the embodiment as described above, the server 10 may determine whether the player owns a particular game content; when the player owns a particular game content, a screen (e.g., My Menu screen 70 in an embodiment) containing a guidance display area for guiding the player to a unit card gasha screen or a character card gasha screen may be displayed on the terminal device 30 in a display mode for notifying a game content recommended based on the particular game content. Thus, the player may be notified of a game content suited to the game contents owned by the player and may be encouraged to obtain the game content.

Additionally, in the server device 10 according to an embodiment of the present invention, the unit card lottery screen guidance display area 77 may contain an image for recommending fusion of a particular game content of a unit card (a game content of a first type) owned by the player with a unit card (e.g., the same unit card) that may produce a special effect when fused with the particular game content. As a result, the player may be encouraged to obtain the game content suited for fusion with the particular game content owned by the player.

Additionally, in the server device 10 according to an embodiment of the present invention, the character card lottery screen guidance display area 78 may contain an image for recommending combination of a particular game content of a unit card (a game content of a first type) owned by the player with a character card (a game content of a second type) that may enables the player to progress the game advantageously when combined with the particular game content. As a result, the player may be encouraged to obtain the game content suited for combination with the particular game content owned by the player.

Additionally, in the server device 10 according to an embodiment of the present invention, the unit card lottery screen guidance display area 77 may contain an image for recommending combination of a particular game content of a character card (a game content of a second type) owned by the player with a unit card (a game content of a first type) that may enables the player to progress the game advantageously when combined with the particular game content. As a result, the player may be encouraged to obtain the game content suited for combination with the particular game content owned by the player.

In the server device 10 according to an embodiment, images including text corresponding to a particular game content may be contained in the guidance display areas such as the unit card lottery screen guidance display area 77 and the character card lottery screen guidance display area 78. However, the screen containing a guidance display area has only to be displayed in a display mode for notifying a game content recommended in accordance with the particular game content; to notify the recommended game content, it is not essential to provide the guidance display area with an image. For example, it may also be possible to display the above text (“Get unit C to raise the upper limit of level!” and “Get character J to combine it with unit C!”) or an image including such text at a position adjacent to or in the vicinity of the guidance display area or other positions in the screen containing the guidance display area.

In the server device 10 according to an embodiment, the unit card lottery screen guidance display area 77 may contain an image for recommending fusion of a particular game content of a unit card (a game content of a first type) owned by the player with a unit card that may produce a special effect when fused with the particular game content. In place of or in addition to this guidance display area, a guidance display area for guiding the player to a screen where the player obtains an item may be provided; and this guidance display area may contain an image including text for encouraging the player to obtain an item (a game content of a third type) recommended for application to the unit card.

In the server device 10 according to an embodiment, the unit card lottery screen guidance display area 77 may guide the player to the unit card gasha screen; and the character card lottery screen guidance display area 78 may guide the player to the character card gasha screen. It may also be possible to guide the player to a screen where the player obtains a card, other than a gasha screen where the player obtains a card through a lottery. For example, the player may be guided to a screen for designating and purchasing a card or a screen for exchanging cards with another player. Further, a guidance display area may guide the player to a screen other than screens for obtaining a card (e.g., the top screen). Even in this case, the player may be notified of a game content suited to a particular game content owned by the player.

In the server device 10 according to an embodiment, examples of screens containing a guidance display area such as the unit card lottery screen guidance display area 77 and the character card lottery screen guidance display area 78 are the top screen, My Menu screen, and a fusion screen. Naturally, other screens used in card games may also contain the guidance display area. Further, screens containing a guidance display area may also be screens of a game other than the card game in the above example (e.g., other card games, games using the same characters other than card games, and other games), screens of a game platform for providing a plurality of games, and screens used in services other than games. Further, icons for starting a card game displayed in a game or on a game platform may also be included in guidance display areas described herein that may guide the player to the top screen or other screens of the card game. For example, if it is determined that the player owns a particular game content in a card game, card game icons on a game platform screen displayed on the terminal of the player may be changed so as to recommend a game content that may produce a combination effect with the particular game content. Alternatively, if it is determined that the player owns a particular game content in a card game, a screen used for services other than games such as chat service and displayed on the terminal of the player may include a guidance display area for recommending a game content that may produce a combination effect with the particular game content. Additionally, in the above example, if the server device providing a card game is different from the server device providing the game platform (or a service other than games), information indicating that it has been determined that the player owns a particular game content in the card game may be sent to the server device providing the game platform from the server device providing the card game.

The processes and procedures described and illustrated herein may also be implemented by software, hardware, or any combination thereof other than those explicitly stated for the embodiments. More specifically, the processes and procedures described and illustrated herein may be implemented by the installation of the logic corresponding to the processes into a medium such as an integrated circuit, a volatile memory, a non-volatile memory, a magnetic disk, or an optical storage. The processes and procedures described and illustrated herein may also be installed in the form of a computer program, and executed by various computers.

Even if the processes and the procedures described herein are executed by a single apparatus, software piece, component, or module, such processes and procedures may also be executed by a plurality of apparatuses, software pieces, components, and/or modules. Even if the data, tables, or databases described herein are stored in a single memory, such data, tables, or databases may also be dispersed and stored in a plurality of memories included in a single apparatus or in a plurality of memories dispersed and arranged in a plurality of apparatuses. The elements of the software and the hardware described herein can be integrated into fewer constituent elements or can be decomposed into more constituent elements.

With respect to the use of substantially any plural and/or singular terms herein, those having skill in the art can translate from the plural to the singular and/or from the singular to the plural as is appropriate to the context.

What is claimed is:

1. A server device communicatively connected to a terminal device and capable of providing a game to a player operating the terminal device, the server device comprising:
a storage unit configured to store owned game content information on game contents owned by the player and used in the game;
a determination unit configured to determine whether the player owns a particular game content based on the owned game content information; and
a display control unit configured to cause the terminal device operated by the player to display, in a particular display mode, a guidance display area for guiding the player to a particular screen used in the game if the determination unit determines that the player does not own the particular game content, and cause the terminal device operated by the player to display the guidance display area in a display mode for notifying a game content recommended based on the particular game content if the determination unit determines that the player owns the particular game content.

2. The server device of claim 1 wherein the particular screen is used by the player to obtain the game content recommended based on the particular game content.

3. The server device of claim 2 wherein the particular screen is used by the player to obtain, through a lottery, the game content recommended based on the particular game content.

4. The server device of claim 1 wherein
the game permits combination of a game content of a first type and a game content of a second type; and,
if it is determined that the player owns the particular game content of the first type, the display control unit causes the terminal device operated by the player to display a first guidance display area for guiding the player to a screen for the player to obtain a game content of the second type in a display mode for notifying a game content of the second type recommended to the player as a game content to be combined with the particular game content.

5. The server device of claim 4 wherein, if it is determined that the player owns the particular game content of the second type, the display control unit causes the terminal device operated by the player to display a second guidance display area for guiding the player to a screen for the player to obtain a game content of the first type in a display mode for notifying a game content of first type recommended for combination with the particular game content, the second guidance display area being different from the first guidance display area.

6. The server device of claim 1 wherein
the game permits applying a second game content of a first type to a first game content of the first type so as to change a first parameter of the first game content; and,
if it is determined that the player owns the particular game content of the first type, the display control unit causes the terminal device operated by the player to display a guidance display area for guiding the player to a screen for the player to obtain a game content of the first type in a display mode for notifying a game content of the first type recommended for application to the particular game content.

7. The server device of claim 1 wherein
the game permits applying a game content of a third type to a game content of a first type so as to reinforce a second parameter of the game content of the first type; and,
if it is determined that the player owns the particular game content of the first type, the display control unit causes the terminal device operated by the player to display a guidance display area for guiding the player to a screen for the player to obtain a game content of the third type in a display mode for notifying a game content of the third type recommended for application to the particular game content.

8. A computer-readable storage medium storing a program for causing a computer to operate as a server device capable of providing a game to a player operating a terminal device communicatively connected to the computer, the computer including a storage unit configured to store owned game content information on game contents used in the game and owned by the player, the program causing the computer to operate as:
a determination unit configured to determine whether the player owns a particular game content based on the owned game content information; and
a display control unit configured to cause the terminal device operated by the player to display, in a particular display mode, a guidance display area for guiding the player to a particular screen used in the game if the determination unit determines that the player does not own the particular game content, and cause the terminal device operated by the player to display the guidance display area in a display mode for notifying a game content recommended based on the particular game content if the determination unit determines that the player owns the particular game content.
